(19) United States
(12) Patent Application Publication
(10) Pub. No.: US 2022/0207028 A1
(43) Pub. Date: Jun. 30, 2022

(54) ELECTRONIC DEVICE AND METHOD FOR PROVIDING INFORMATION ON ELECTRONIC DEVICE

(71) Applicant: SAMSUNG ELECTRONICS CO., LTD., Suwon-si (KR)

(72) Inventors: Myoungsoo Park, Suwon-si (KR); Howoon Kang, Suwon-si (KR); Kyoweon Kim, Suwon-si (KR); Taehyung Kim, Suwon-si (KR); Jaewon Jung, Suwon-si (KR)

(21) Appl. No.: 17/696,288

(22) Filed: Mar. 16, 2022

Related U.S. Application Data
(63) Continuation of application No. PCT/KR2020/012032, filed on Sep. 7, 2020.

(30) Foreign Application Priority Data
Sep. 17, 2019 (KR) 10-2019-0114329

(51) Int. Cl. G06F 16/248

(52) U.S. Cl. CPC G06F 16/248

(57) ABSTRACT

Disclosed is an electronic device. An electronic device according to an embodiment may comprise: a display; a memory; and a processor electrically connected to the display and the memory. According to an embodiment, the memory may store instructions that, when executed, cause the processor to: retrieve information related to the hardware configuration of the electronic device from a database based on identification information or status information of the electronic device; and provide the information related to the hardware configuration to at least one application stored in the memory. According to an embodiment, the information related to the hardware configuration may include coordinate information set based on a display characteristic of the electronic device.

### CROSS-REFERENCE TO RELATED APPLICATIONS

This application is a continuation of International Application No. PCT/KR2020/012032 designating the United States, filed on Sep. 7, 2020, in the Korean Intellectual Property Receiving Office and claiming priority to Korean Patent Application No. 10-2019-0114329, filed on Sep. 17, 2019, in the Korean Intellectual Property Office, the disclosures of which are incorporated by reference herein in their entireties.

### BACKGROUND

### Field

The disclosure relates to a technology for providing information related to a hardware component of an electronic device.

### Description of Related Art

Recently, electronic devices having various functions or components have been widely distributed, and it is common that the electronic device includes a plurality of hardware components to perform the various functions. For example, the electronic device may include an antenna, a microphone, a camera, and various sensors. In particular, as various electronic devices are developed and distributed, hardware components included in the electronic devices and arrangement of the hardware components are also variously changed. For example, even the same hardware component may be disposed at a different position inside the electronic device depending on a type of electronic device.

### SUMMARY

Embodiments of the disclosure provide an electronic device and a method for providing information of the electronic device that may provide information related to a hardware component included in the electronic device, and provide an interface configured based on the information related to the hardware component included in the electronic device.

An electronic device according to an example embodiment disclosed in the disclosure includes: a display, a memory, and a processor electrically connected to the display and the memory. According to an embodiment, the memory stores instructions that, when executed, cause the processor to: search for information related to a hardware component of the electronic device from a database based on identification information or state information of the electronic device; and provide the information related to the hardware component to at least one application stored in the memory. According to an embodiment, the information related to the hardware component may include coordinate information set based on characteristics of the display of the electronic device.

In addition, a method for providing information of an electronic device according to an example embodiment disclosed in the disclosure includes: searching for information related to a hardware component of the electronic device from a database based on identification information of the electronic device or state information of the electronic device; and providing the information related to the hardware component to at least one application stored in a memory of the electronic device. According to an embodiment, the information related to the hardware component may include coordinate information set based on characteristics of a display of the electronic device.

According to various example embodiments of the disclosure, the information related to the hardware component included in the electronic device may be provided through the display of the electronic device.

According to various example embodiments of the disclosure, a hardware component and a user manipulation method required to perform a function of the electronic device may be provided.

According to various example embodiments of the disclosure, various interfaces (e.g., a content, feedback, and information) configured based on the information related to the hardware component included in the electronic device may be provided.

According to various example embodiments of the disclosure, an application programming interface (API) capable of providing the information related to the hardware component included in each device in different electronic devices may be provided.

In addition, various effects that are directly or indirectly identified through the disclosure may be provided.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device 101 in a network environment according to various embodiments;

FIG. 2 is a block diagram illustrating an example configuration of a program according to various embodiments;

FIG. 3 is a block diagram illustrating an example configuration of an electronic device according to various embodiments;

FIGS. 4A and 4B are diagrams illustrating coordinate information according to various embodiments;

FIG. 5 is a signal flow diagram illustrating an example information providing operation of an electronic device according to various embodiments;

FIG. 6 is a signal flow diagram illustrating an example information providing operation of an electronic device according to various embodiments;

FIG. 7 is a diagram illustrating an example of hardware hierarchical information of an electronic device according to various embodiments;

FIG. 8 is a diagram illustrating an example of data flow according to various embodiments;

FIGS. 9A and 9B are diagrams illustrating an example coordinate conversion operation of an electronic device according to various embodiments;

FIG. 10 is a diagram illustrating an example of an interface provided by an electronic device according to various embodiments;

FIG. 11 is a diagram illustrating an example of an interface provided by an electronic device according to various embodiments

FIG. 12 is a diagram illustrating an example of an interface provided by an electronic device according to various embodiments;

FIGS. 13A and 13B are diagrams illustrating an example of an interface provided by an electronic device according to various embodiments;

FIG. 14 is a diagram illustrating an example of an interface provided by an electronic device according to various embodiments;

FIG. 15 is a flowchart illustrating an example information providing method of an electronic device according to various embodiments;

FIG. 16 is a flowchart illustrating an example information providing method of an electronic device according to various embodiments; and

FIG. 17 is a flowchart illustrating an example information providing method of an electronic device according to various embodiments.

In connection with description of the drawings, the same or similar reference numerals may be used for the same or similar components.

### DETAILED DESCRIPTION

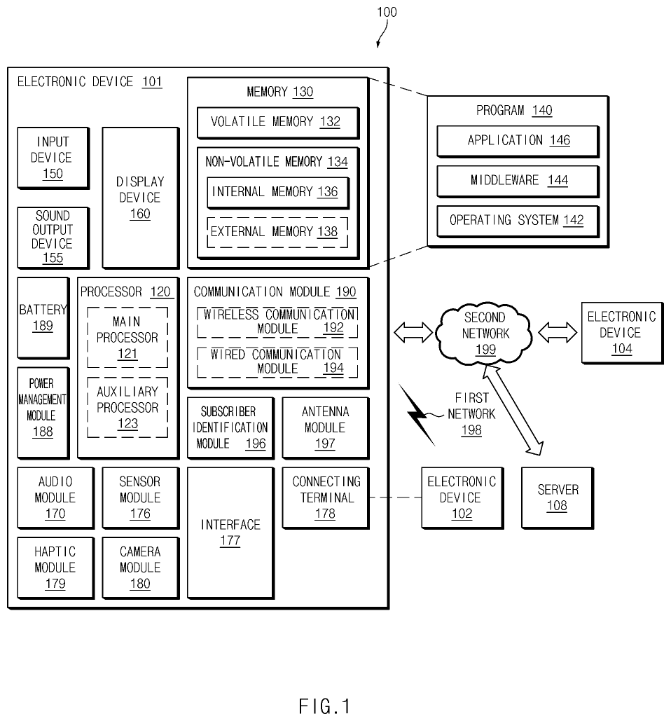

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In various embodiments, at least one (e.g., the display device 160 or the camera module 180) of the components may be omitted from the electronic device 101, or one or more other components may be added in the electronic device 101. In various embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

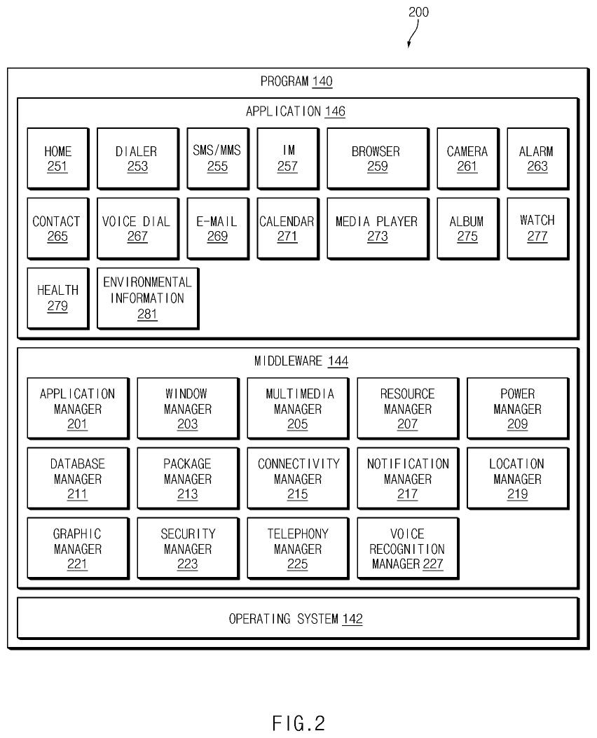

FIG. 2 is a block diagram 200 illustrating an example configuration of the program 140 according to various embodiments. According to an embodiment, the program 140 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input device 150, the sound output device 155, the display device 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130.The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or a video call function provided by the electronic device 101. The voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment, the middleware 244 may dynamically delete some existing components or add new components. According to an embodiment, at least part of the middleware 144 may be included as part of the OS 142 or may be implemented as another software separate from the OS 142.

The application 146 may include, for example, a home 251, dialer 253, short message service (SMS)/multimedia messaging service (MMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to an embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control the power (e.g., turn-on or turn-off) or the function (e.g., adjustment of brightness, resolution, or focus) of the external electronic device or some component thereof (e.g., a display device or a camera module of the external electronic device). The device management application, additionally or alternatively, may support installation, delete, or update of an application running on the external electronic device.

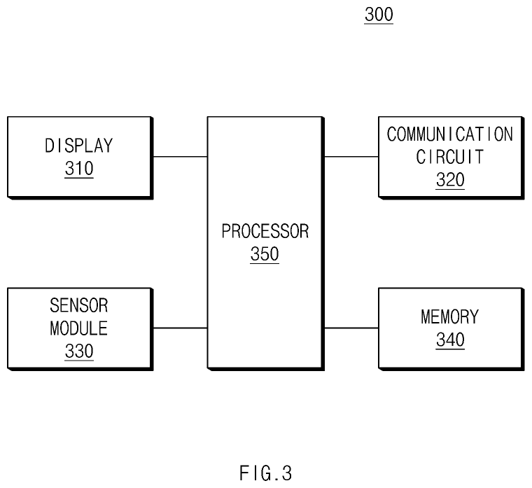

FIG. 3 is a block diagram illustrating an example configuration of an electronic device (e.g., the electronic device 101 in FIG. 1) according to various embodiments.

According to an embodiment, a display 310 (e.g., the display device 160 in FIG. 1) may output various information (e.g., information related to a hardware component of an electronic device 300, a content, a manipulation method, or an interface) provided by the electronic device 300.

According to an embodiment, a communication circuit 320 (e.g., the communication module 190 in FIG. 1) may support establishment of a communication channel between the electronic device 300 and an external device (e.g., the external electronic device 300, a server, or a database) and performance of wired or wireless communication through the established communication channel. For example, the communication circuit 320 may receive information from the external database of the electronic device 300 or store information generated or stored in the electronic device 300 in the external database. For example, the communication circuit 320 may transmit/receive information (e.g., physical coordinate information or software coordinate information) related to the hardware component to/from the external database.

According to an embodiment, a sensor module 330 (e.g., the sensor module 176 in FIG. 1) may include various sensors measure or sense an internal state or an external state of the electronic device 300. For example, the sensor module 330 may include at least one of a light sensor, a gravity sensor, an acceleration sensor, a proximity sensor, an NFC sensor, and a camera sensor (e.g., the camera module 180 in FIG. 1). According to various embodiments, the sensor included in the sensor module 330 may not be limited to the above examples and various types of sensors may be further included.

According to an embodiment, a memory 340 (e.g., the memory 130 in FIG. 1) may store the information generated by the electronic device 300 or the information received from the external device. According to an embodiment, the memory 340 may store a command or data related to a software component (e.g., a program (e.g., the program 140 in FIGS. 1 and 2)) of the electronic device 300. According to an embodiment, the program may store an application, an application framework, and an application programming interface (API) called by the application. According to an embodiment, the memory 340 may store the information related to the hardware component of the electronic device 300. According to an embodiment, the memory 340 may include a database for storing the information (e.g., the physical coordinate information or the software coordinate information) related to the hardware component. According to an embodiment, the information related to the hardware component may include coordinate information set based on characteristics of the display 310 (e.g., a size, a position, or a resolution of the display 310) of the electronic device 300. For example, the physical coordinate information may include three-dimensional coordinate information, and the software coordinate information may include two-dimensional coordinate information converted based on the resolution and the position of the display 310. For example, the software coordinate information may include coordinate values of pixels of the display 310.

According to an embodiment, a processor 350 (e.g., the processor 120 in FIG. 1) may include various processing circuitry and search for the information related to the hardware component of the electronic device 300 from the database based on identification information or state information of the electronic device 300. According to an embodiment, when the information related to the hardware component is requested from an application stored in the memory 340, the processor 350 may search for the requested information related to the hardware component. For example, the identification information of the electronic device 300 may include information indicating a type of the electronic device 300 (e.g., an ID of the electronic device 300). For example, the state information of the electronic device 300 may include information indicating a folded state of the electronic device 300. For example, when the display 310 of the electronic device 300 is a foldable display (or a flexible display) that may be folded, the state information of the electronic device 300 may include the information indicating the folded state of the electronic device 300. According to various embodiments, the database may be included outside of the electronic device 300 (e.g., in the external device or the external server), and may be included inside of the electronic device 300 (e.g., in the memory 340 of the electronic device 300).

According to an embodiment, the processor 350 may search for information of the hardware component and a lower hierarchical hardware component requested based on hardware hierarchical information. For example, the hardware hierarchical information may be information that hierarchically classifies various hardware components that may be included in the electronic device 300. According to an embodiment, the processor 350 may provide at least one found information of the hardware component as the information related to the hardware component. According to an embodiment, the information related to the hardware component may include the software coordinate information of the hardware component.

According to an embodiment, the processor 350 may obtain the physical coordinate information of the hardware component from the database, and convert the physical coordinate information into the software coordinate information. For example, the processor 350 may process an API for converting physical coordinate information below into software coordinate information through the framework. For example, the processor 350 may convert the physical coordinate information for the hardware component into the software coordinate information such that a position where the hardware component included in the electronic device 300 is disposed in the electronic device 300 may be expressed on the display 310.

For example, the database may store specifications of the electronic device 300 (e.g., a width and a height of the electronic device 300). For example, the database may store the physical coordinate information for the hardware component included in the electronic device 300 for each type of the electronic device 300. For example, the physical coordinate information for the hardware component may be stored in the database in a development stage of the electronic device 300 or may be stored in the database by the electronic device 300. For example, the physical coordinate information may contain physical coordinate values of two points (e.g., an upper left end and a lower right end) corresponding to each other in a virtual rectangle containing the hardware component. For example, the processor 350 may determine a physical difference (an offset) based on the size and an arrangement of the display 310 in the electronic device 300. For example, the processor 350 may identify the physical size of the display 310 and determine a ratio between the physical size and the resolution of the display 310. For example, the physical size of the display 310 may have a value in mm, and the resolution of the display 310 may have a value in pixels. For example, the processor 350 may obtain the software coordinate information using the physical coordinate information, the offset, and the ratio of the hardware component. For example, the electronic device 300 may obtain the software coordinate information indicating at which position on the display 310 the hardware component included in the electronic device 300 exists. For example, when the software coordinate information is generated, the processor 350 may correct a coordinate value outside a region of the display 310 to coordinates on the region of the display 310 closest based on an L1 distance (a Manhattan distance). According to an embodiment, the processor 350 may store the converted software coordinate information in the database.

According to an embodiment, the processor 350 may output an interface configured based on the information related to the hardware component through the display 310. According to an embodiment, the interface may contain at least one information of a size, a position, a use, and a usage of the hardware component, or a visual representation or a content related to the at least one information. For example, the processor 350 may output an interface related to a position or a usage of a specific hardware component with respect to a function executable using the corresponding specific hardware component in the electronic device 300. For example, the processor 350 may output a content (e.g., a wallpaper) configured using the information related to the hardware component (e.g., the position of the hardware component (e.g., a camera)).

According to various embodiments of the disclosure, the electronic device 300 may provide the API that may be used regardless of the type of the electronic device 300, thereby, when the API is called from an application included in the arbitrary electronic device 300, obtaining the information related to the hardware component (e.g., the software coordinate information) corresponding to the corresponding electronic device 300 from the database and providing the obtained information to the application. For example, according to various embodiments disclosed in the disclosure, an interface or a content that is adaptively changed based on the information related to the hardware component (e.g., the position, an arrangement, and whether of being included of the hardware component) of each device may be output through the same application in different devices.

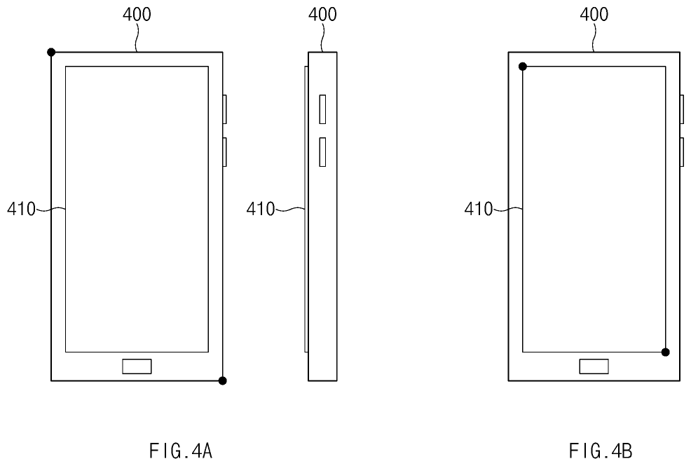

FIGS. 4A and 4B are diagrams illustrating example coordinate information according to various embodiments.

According to an embodiment, the physical coordinate information or the software coordinate information may be stored in a database located inside or outside an electronic device 400 (e.g., the electronic device 101 in FIG. 1 and the electronic device 300 in FIG. 3). According to an embodiment, the electronic device 400 may convert the physical coordinate information into the software coordinate information. According to an embodiment, FIG. 4A represents the physical coordinate information, and FIG. 4B represents the software coordinate information.

According to an embodiment, the physical coordinate information may include three-dimensional coordinate information for a hardware component of the electronic device 400. For example, the physical coordinate information may include absolute coordinate information for each position of the electronic device 400 based on a point of the electronic device 400 (e.g., a left uppermost end of the electronic device 400). For example, the physical coordinate information may use mm units. For example, the physical coordinate information may have a value of (X mm, Y mm, Z mm) for a horizontal axis (an X axis), a vertical axis (a Y axis), and a width (a Z axis). According to an embodiment, information related to the Z-axis in the physical coordinate information may be set based on some components or the position of the electronic device 400 for simplification of the information. For example, the Z axis-related information of the physical coordinate information may be set to one of a ‘front’ exposed to the outside of a housing of the electronic device 400 and representing a front surface, an ‘edge’ exposed to the outside of the housing of the electronic device 400 and representing a side surface, a ‘back’ exposed to the outside of the housing of the electronic device 400 and representing a rear surface, and an ‘inside’ representing an interior of the housing of the electronic device 400. For example, the front surface (e.g., the ‘front’) exposed to the outside of the housing of the electronic device 400 may be subdivided into an ‘onscreen’ representing a portion of a display 410 of the electronic device 400 and an ‘offscreen’ representing an external portion of the display 410 of the electronic device 400. For example, the physical coordinate information may have a value such as (X mm, Y mm, edge). For example, in a case of a hardware component that the electronic device 400 does not include, the physical coordinate information may be set to a value such as a ‘none’.

According to an embodiment, the software coordinate information may be two-dimensional coordinate information set based on the display 410 of the electronic device 400. For example, the software coordinate information may be relative coordinates with respect to a position in the display 410 based on one point of the display 410 (e.g., a left uppermost end of the display 410). For example, the software coordinate information, which is two-dimensional coordinates on a plane of the display 410, may use pixel units. For example, the software coordinate information may have a value of (X pixel, Y pixel) with respect to the horizontal axis (the X axis) and the vertical axis (the Y axis) of the display 410.

According to an embodiment, the software coordinate information may have a different value based on a state of the electronic device 400. For example, when the electronic device 400 includes the foldable (flexible) display 410, the software coordinate information for the same hardware component may be changed based on a folded state of the display 410. For example, when the display 410 is folded in half, the software coordinate information may be set for substantially half of the display 410.

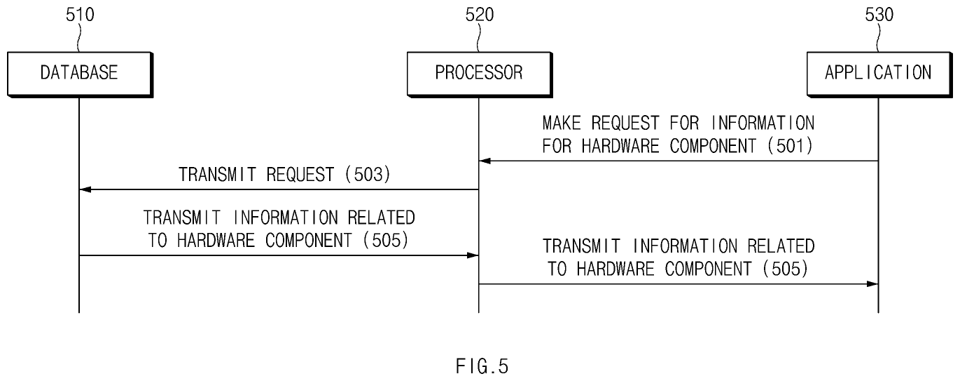

FIG. 5 is a signal flow diagram illustrating an example information providing operation of an electronic device (e.g., the electronic device 101 in FIG. 1 and the electronic device 300 in FIG. 3) according to various embodiments. For example, FIG. 5 illustrates a case in which an application 530 stored in the electronic device requests the information by specifying a specific hardware component of the electronic device and a state of the electronic device.

According to an embodiment, in operation 501, the application 530 may make a request for the information for the hardware component of the electronic device to a processor 520. For example, the application 530 may transmit, to the processor 520, a request containing information of the electronic device (e.g., an ID of the electronic device), state information of the electronic device, and a name of a hardware component for which the information is desired.

According to an embodiment, the processor 520 may communicate with the application 530 via the framework. For example, the application 530 may call an application programming interface (API) that makes a request for the information for the hardware component of the electronic device to the processor 520 (e.g., the framework). According to an embodiment, the application 530 may request the information by specifically specifying the hardware component for which the information is desired. For example, the application 530 may call the ID of the electronic device, the state of the electronic device, and an API containing the hardware component (e.g., getPosition (the ID (e.g., SM-F9000F) of the electronic device), the state (e.g., folded) of the electronic device and the hardware component (a front camera)). For example, when the electronic device includes the foldable display, the state of the electronic device may include folded state information of the electronic device (the foldable display).

According to an embodiment, in operation 503, the processor 520 may transmit the request received from the application 530 to a database 510. For example, the processor 520 may forward the API received from the application 530 to the database 510. For example, the processor 520 may make a request for the information related to the hardware component corresponding to the request received from the application 530 to the database 510. According to an embodiment, the processor 520 may search for the information related to the hardware component from the database 510 based on the request received from the application 530. For example, when information for the front camera of the electronic device is requested from the application, the processor 520 may search for the information related to the corresponding hardware component (e.g., the front camera) from the database 510. According to an embodiment, the processor 520 may search for the information related to the hardware component corresponding to the state of the electronic device. For example, when the electronic device includes the foldable display, the software coordinate information for the hardware component may be different based on the folded state of the electronic device. For example, the software coordinate information for the hardware component, which is relative coordinate information based on a pixel of the display of the electronic device, may be different depending on the folded state of the electronic device. For example, the processor 520 may recognize the state of the electronic device and search for the software coordinate information corresponding to the state of the electronic device from the database 510.

According to an embodiment, in operation 505, the database 510 may transmit the information for the hardware component to the processor 520. For example, the database 510 may transmit the information related to the hardware component (e.g., the software coordinate information) corresponding to the received request (or the API) to the processor 520 (e.g., the framework).

According to an embodiment, in operation 507, the processor 520 (e.g., the framework) may transmit the information related to the hardware component received from the database 510 to the application 530.

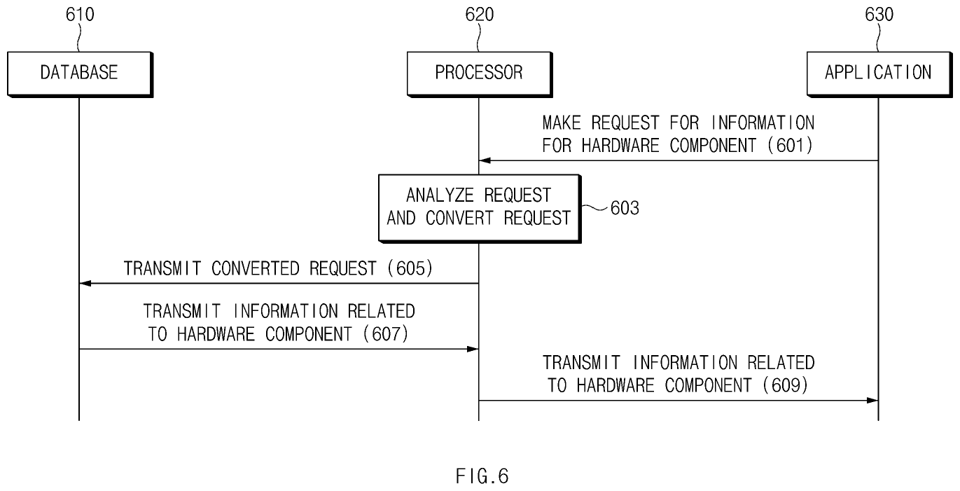

FIG. 6 is a signal flow diagram illustrating an example information providing operation of an electronic device (e.g., the electronic device 101 in FIG. 1 and the electronic device 300 in FIG. 3) according to various embodiments. For example, FIG. 6 illustrates a case in which an application 630 requests the information without specifying the specific hardware component of the electronic device and the state of the electronic device.

According to an embodiment, in operation 601, the application 630 may make a request for the information for the hardware component of the electronic device to a processor 620 (e.g., the framework). For example, the application 630 may call an application programming interface (API) that makes a request for information for a hardware type to the processor 620 without specifying the specific hardware component of the electronic device. For example, the application 630 may transmit the request containing the type of the hardware component or the API (e.g., getPosition (the type of the hardware component (e.g., the camera))) to the processor 620.

According to an embodiment, in operation 603, the processor 620 may analyze the request (e.g., the API) received from the application 630 and convert the request. For example, when information related to the camera is requested from the application 630, the processor 620 may determine the hardware component requested by the application 630 based on at least one of the type or the ID of the electronic device, the state of the electronic device (e.g., the folded state of the foldable display), a type and an attribute of the application 630, and an execution state of the application 630. For example, when the application 630 requests the information for the camera, the processor 620 may determine which information the application 630 has requested among information for the front camera, a rear camera, or all cameras. According to an embodiment, the processor 620 may recognize the hardware component and a lower hardware component requested by the application 630 based on the hardware hierarchical information. For example, when the application 630 requests information for a hardware component of a parent class, the processor 620 may recognize the requested hardware component of the parent class and a hardware component of a lower child class, and change the request (e.g., the API) of the application 630 based on the recognized hardware components. For example, when the application 630 requests the information of the camera, the processor 620 may recognize the camera, and the front camera and the rear camera of the child class thereof. According to an embodiment, when the specific hardware component requested by the application 630 is not able to be specified, the electronic device may convert the API to request information related to the hardware components of the lower child class with respect to the hardware component requested by the application 630 based on the hardware hierarchical information.

According to an embodiment, the processor 620 may convert the request received from the application 630 based on the recognized ID of the electronic device, state of the electronic device, and/or hardware component. For example, the processor 620 (e.g., the framework) may convert the API received from the application 630 based on the recognized ID of the electronic device, state of the electronic device, and/or hardware component.

According to an embodiment, in operation 605, the processor 620 may transmit the converted request to a database 610. For example, the processor 620 (e.g., the framework) may transmit the converted API to the database 610. For example, the processor 620 may search for information for a hardware component and a lower hardware component thereof corresponding to the converted request (e.g., the API) from the database 610.

According to an embodiment, in operation 607, the database 610 may transmit the information for the hardware component to the processor 620. For example, the database 610 may transmit, to the processor 620 (e.g., the framework), the information related to the hardware component (e.g., the software coordinate information) corresponding to the request (or the API) converted by the processor 620 (e.g., the framework). For example, the database 610 may transmit the information for the related hardware component (e.g., the information of the front camera and the rear camera) to the processor 620 based on the request (e.g., the API) received from the processor 620.

According to an embodiment, in operation 609, the processor 620 (e.g., the framework) may transmit the information related to the hardware component received from the database 610 to the application 630.

According to various embodiments, when the exact hardware component is not specified from the application 630, the electronic device (e.g., the processor 620) may search for and provide the information for the related hardware component (e.g., the hardware component of the child class) from the database 610.

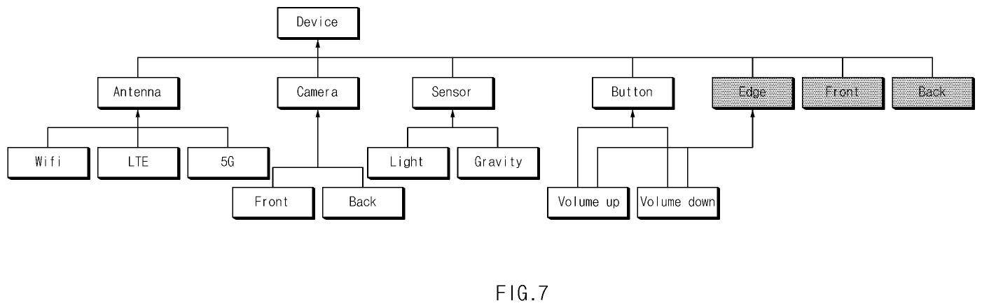

FIG. 7 is a diagram illustrating an example of hardware hierarchical information of an electronic device according to various embodiments.

According to an embodiment, the electronic device may search for the information of the hardware component and the hardware component of the lower hierarchy requested from the application from the database based on the hardware hierarchical information.

The hardware hierarchical information may be, for example, information that hierarchically classifies various hardware components that may be included in the electronic device.

For example, the electronic device (Device) may include hardware components of an antenna, a camera, a sensor, and a button, and may include physical components at a front surface (front), a rear surface (back), and a side surface (edge).

For example, the antenna as the parent class may include a Wi-Fi antenna, an LTE antenna, and a 5G antenna as the child class. For example, the camera as the parent class may include the front camera (front) and the rear camera (back) as the child class. For example, the sensor as the parent class may include a light sensor (light) and a gravity sensor (gravity) as the child class. For example, one hardware component may include a plurality of child classes or may be included in a plurality of parent classes. For example, a volume up button and a volume down button may belong to both a child class of the button and a child class of the side surface.

According to various embodiments, the hardware hierarchical information shown in FIG. 7 is merely an example, and the present disclosure is not limited thereto. Hardware hierarchical information similar to that shown in FIG. 7 may be set for each of the various hardware components that may be included in the electronic device.

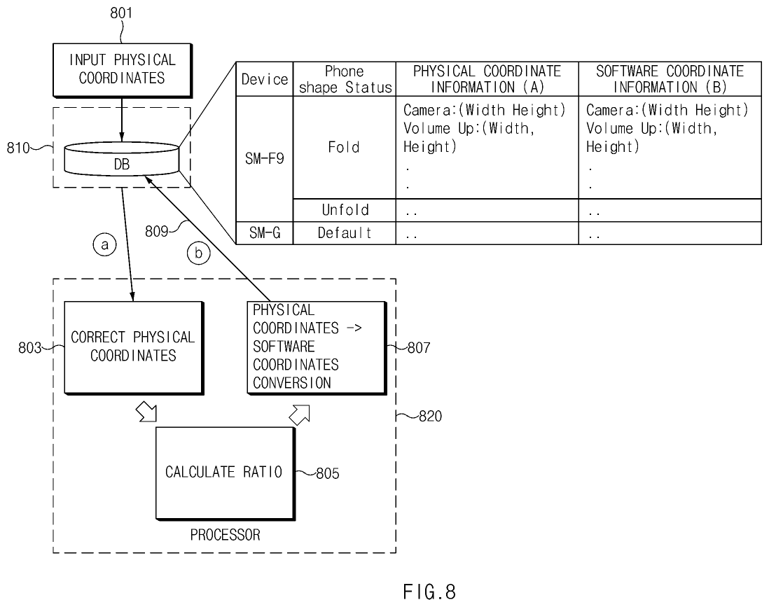

FIG. 8 is a diagram illustrating an example of data flow according to various embodiments.

According to an embodiment, a database 810 may store information (e.g., physical coordinates and software coordinates) for the hardware component for each device. FIG. 8 shows that the database 810 is located outside the electronic device (e.g., the electronic device 101 in FIG. 1 and the electronic device 300 in FIG. 3). However, according to various embodiments, the database 810 may be included inside (e.g., in the memory) of the electronic device.

According to an embodiment, in operation 801, physical coordinate information (a) may be stored in the database 810. For example, the physical coordinate information (a), which may include coordinates for the hardware component of the electronic device, may include three-dimensional coordinate information. For example, the physical coordinate information (a) may include coordinate information for each hardware component included in the electronic device for each electronic device. For example, the physical coordinate information (a) may include 3D coordinate information for the hardware component of the electronic device. For example, the physical coordinate information (a) may include absolute coordinate information for each position of the electronic device based on one point of the electronic device (e.g., a left uppermost end of the electronic device). For example, the physical coordinate information (a) may use the mm units. For example, the physical coordinate information (a) may have the value of (X mm, Y mm, Z mm) for the horizontal axis (the X axis), the vertical axis (the Y axis), and the width (the Z axis). According to an embodiment, the physical coordinate information (a) related to the hardware component may be pre-stored in the database 810 in a development or commercialization stage of the electronic device.

According to an embodiment, in operation 803, a processor 820 may obtain the physical coordinate information (a) from the database 810. According to an embodiment, the processor 820 may correct the physical coordinates. For example, when defining the coordinates based on a main body of the electronic device, the hardware component (e.g., a side button) of some electronic devices may be out of a range of the main body (e.g., a housing) of the electronic device. For example, when the physical coordinate information (a) of the hardware component is out of the range of the main body of the electronic device, the electronic device may correct the physical coordinate information (a) of the hardware component to be in the range of the main body of the electronic device.

According to an embodiment, in operation 805, the processor 820 may determine a ratio between the physical coordinate information (a) and software coordinate information (b). For example, the processor 820 may determine a conversion ratio (pixel/mm) between the physical coordinate information (a) using the mm units and the software coordinate information (b) using the pixel units. For example, the electronic device may determine a size of the display based on the physical coordinate information (a) of the electronic device stored in the database 810, and calculate a ratio of the display (in pixels) to the physical size of the display (in mm). For example, in determining the ratio of the physical coordinate information (a) and the software coordinate information (b), the processor 820 may calculate a ratio of a one-dimensional vector value to one axis direction (e.g., the horizontal direction or the vertical direction) of the display. For example, the processor 820 may calculate a ratio between a physical horizontal length of the display and the number of horizontal pixels of the display, or may calculate a ratio between a physical vertical length of the display and the number of vertical pixels of the display.

According to an embodiment, in operation 807, the processor 820 may convert the physical coordinate information (a) into the software coordinate information (b) based on the determined ratio. For example, the software coordinate information (b) may include coordinate information of the nearest pixel on the display corresponding to a physical position of the hardware component. For example, to solve an error caused by a difference in size and position of the main body of the electronic device and the display, the processor 820 may correct the software coordinate information converted by applying the ratio to the software coordinate information (b) on the display closest based on the L distance (e.g., the Manhattan distance).

For example, the processor 820 may convert the physical coordinate information (a) for the hardware component into the software coordinate information (b), thereby, when providing the information related to the hardware component (e.g., the position of the hardware component) to the display, providing the corresponding information related to the hardware component based on pixel coordinates of the display.

According to an embodiment, in operation 809, the processor 820 may store the converted software coordinate information (b) in the database 810. According to an embodiment, the database 810 may store the physical coordinate information (a) and the software coordinate information (b) of each hardware component classified based on the type (ID) of the electronic device and the state of the electronic device. According to an embodiment, when the information for the hardware component is requested from the application, the processor 820 may search for the software coordinate information (b) stored in the database 810 and provide the software coordinate information (b) to the application. For example, when the application calls the API that requests the information for the hardware component, the processor 820 (the framework) may convert the physical coordinates of the corresponding hardware component from the database 810 into the software coordinate information (b) and provide the software coordinate information (b), or search for the software coordinate information (b) related to the hardware component that is previously converted and stored in the database 810 and provide the software coordinate information (b) to the application.

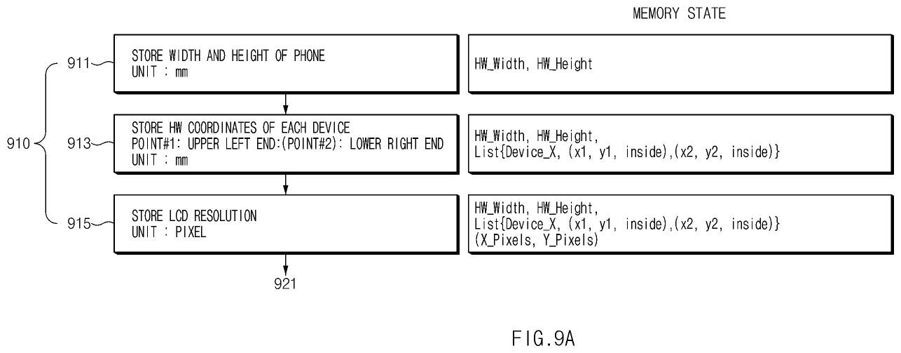

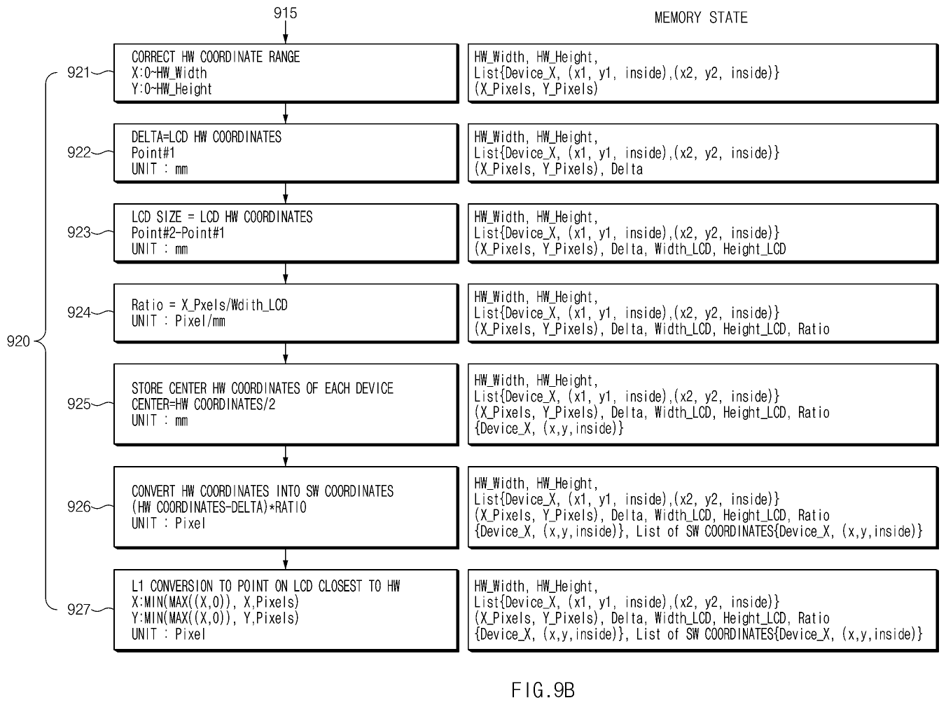

Hereinafter, a more specific coordinate conversion operation according to an embodiment will be described in greater detail with reference to FIGS. 9A and 9B.

FIGS. 9A and 9B are diagrams illustrating an example coordinate conversion operation of the electronic device (e.g., the electronic device 101 in FIG. 1 and the electronic device 300 in FIG. 3) according to various embodiments.

According to an embodiment, the electronic device (e.g., the processor) may convert the physical coordinate information stored in the database into the software coordinate information. For example, the processor may process the API that converts the physical coordinate information below into the software coordinate information through the framework.

According to an embodiment, 910 represents information that is previously stored (input) in the database, and a memory state, and 920 represents a calculation method and a memory state of when the electronic device calculates the software coordinate information based on the information stored in the database. For example, the memory state indicates a type and a format of the information stored in the database or the memory of the electronic device.

According to an embodiment, in operation 911, a specification of the electronic device (e.g., a portable terminal) may be stored (input) in the database. For example, the specification of the electronic device may use the mm units. For example, in operation 911, information of a width (HW_Width) of the electronic device and a height (HW_Height) of the electronic device may be stored (input) in the database. Hereinafter, it is assumed that the width (HW_Width) of the electronic device is 100 mm and the height (HW_height) is 150 mm.

According to an embodiment, in operation 913, the database may store (input) the physical coordinate information (HW coordinates) of each device (that is, the hardware component) included in the electronic device. According to an embodiment, the physical coordinates of the hardware component may be defined as values of coordinates (Point11) of an upper left end and coordinates (Point12) of a lower right end of a minimum virtual rectangle containing the corresponding hardware component. For example, in operation 913, information of List {hardware component name (Device X), Point11 coordinates (x1, y1, inside), Point12 coordinates (x2, y2, inside)} may be stored (input) in the database.

According to an embodiment, in operation 915, the database may store information of a characteristic (e.g., a resolution) of the display (e.g., an LCD) of the electronic device. For example, the resolution of the display may use the pixel units. For example, in operation 915, the information of the resolution (X_pixels, Y_Pixels) of the display may be stored in the database. Hereinafter, it is assumed that the resolution of the display of the electronic device is (720 pixels, 1280 pixels).

For example, in operation 921, the electronic device may correct the physical coordinate information stored in operation 913. For example, when defining the coordinates based on the main body of the electronic device, some hardware components (e.g., the side button) of the electronic device may be out of a coordinate range of the electronic device. For example, when the physical coordinate information of the hardware component is out of a specification range of the electronic device, the electronic device may correct the physical coordinate information of the hardware component to be in the specification range of the electronic device. For example, when physical coordinate information of the volume up button is {VolumeUP, (−10, 40, edge), (0, 60, edge)}, the electronic device may correct the physical coordinate information like {VolumeUP, (0, 40, Edge), (0, 60, edge)}. For example, when physical coordinate information of a power button is {Power, (100, 20, edge), (110, 50, edge)}, the electronic device may correct the physical coordinate information like {Power, (100, 20, edge), (100, 50, edge)}. For example, the electronic device may correct the physical coordinates of each hardware component included in the electronic device to be in the range based on the specification of the electronic device (that is, in a range from 0 to 100 mm for the X axis (the width) and in a range from 0 to 150 mm for the Y axis (the height).

According to an embodiment, in operation 922, the electronic device may set an offset (Delta) between the physical coordinate information and the software coordinate information. For example, because the physical coordinate information is defined for an entire region of the electronic device and the software coordinate information is defined for a region within the display of the electronic device, the offset may occur between the physical coordinate information and the software coordinate information. For example, the electronic device may set the (Point11) coordinates of the physical coordinate information of the display as the offset. For example, when the physical coordinate information of the display is {LCD, (10, 10, front), (90, 140, front)}, the electronic device may set the offset (Delta) to (10, 10). For example, the offset (Delta) may use the mm units.

According to an embodiment, in operation 923, the electronic device may calculate the size of the display. For example, the electronic device may recognize the size of the display based on the physical coordinate information of the display. For example, when the Point11 coordinate value is subtracted from the Point12 coordinate value of the physical coordinate information of the display, the size of the display may be obtained. For example, when the physical coordinate information of the display is {LCD, (10, 10, front), (90, 140, front)}, by subtracting the coordinate value of the Point11 (10, 10) from the coordinate value of the Point12 (90, 140), a value (80, 130) may be obtained. For example, the electronic device may recognize that a width (Width_LCD) of the display is 80 mm and a height (Height_LCD) of the display is 130 mm.

According to an embodiment, in operation 924, the electronic device may recognize the ratio of the physical coordinate information and the software coordinate information based on the resolution of the display. For example, the ratio may use the pixel/mm units. For example, the electronic device may calculate the ratio by dividing one of horizontal and vertical pixel values indicating the resolution of the display by one of the width and the height of the corresponding display. For example, the ratio may be calculated using one of one-dimensional vectors (the X-axis (the width) or the Y-axis (the height)). For example, when the resolution of the display (LCD) is (720, 1280), the width (Width_LCD) of the display is 80 mm, and the height (Height_LCD) of the display is 130 mm, the ratio may be 720/80=9 pixel/mm when the ratio is calculated based on the width.

According to an embodiment, in operation 925, the electronic device may recognize physical coordinate information that is a center of each device (that is, each hardware component). For example, the electronic device may calculate center coordinates of the hardware component by adding the Point11 coordinate value and the Point12 coordinate value of the physical coordinate information of the hardware component to obtain a sum and then dividing the sum by two. For example, when the physical coordinate information of an NFC module is {NFC, (35, 45, inside), (55, 95, inside)}, physical coordinate information for a center of the NFC module may be {NFC, (45, 70, inside)}. For example, when the physical coordinate information of the volume up button is {VolumeUp, (0, 40, edge), (0, 60, edge)}, physical coordinate information for a center of the volume up button may be {VolumeUp, (0, 50), edge}.

According to an embodiment, in operation 926, the electronic device may calculate the software coordinate information of the hardware component using the physical coordinate information for the center of the hardware component, the offset (Delta), and the ratio. For example, the electronic device may obtain the software coordinate information by calculating (the physical coordinate information for the center of the hardware component-offset (Delta))*ratio. For example, the software coordinate information may use the pixel units.

For example, in the case of the NFC module described above, the electronic device

may obtain coordinate information of

({NFC, (45, 70, inside)}-Delta(10, 10))*Ratio(9)

={NFC, (315, 720, inside)}.

As another example, in the case of the volume up button described above, the electronic device

may obtain software coordinate information of

({VolumeUp, (0, 50, edge)}-Delta(10, 10))*Ratio(9)

={VolumeUp, (−90, 360, edge)}.

According to an embodiment, in operation 927, the electronic device may convert the software coordinate information obtained in operation 926 into the software coordinate information on the display closest based on the L1 distance (e.g., the Manhattan distance). For example, the electronic device may obtain a X coordinate value of the software coordinate information through calculation of Min(Max(x1, 0), X_pixels), and obtain a Y coordinate value of the software coordinate information through calculation of Min(Max(y1, 0), Y_pixels). For example, x1 and y1 may be values of the software coordinate information obtained in operation 925.

For example, assuming that the software coordinate information of the NFC module, the volume up button, and the power button obtained in operation 925 are respectively as follows:

{NFC, (315, 720, inside)}

{VolumeUp, (−90, 360, edge)}

{Power, (810, 200, edge)},

The electronic device may convert (correct) the software coordinate information above to the software coordinate information on the display closest based on the L1 distance to finally

obtain software coordinate information of

{NFC, (315, 720, inside)}

{VolumeUp, (−90, 360, edge)}

{Power, (720, 200, edge)}.

According to an embodiment, the finally obtained software coordinate information may be coordinates corresponding to one point (a pixel) on the display. For example, in providing a position for an arbitrary hardware component, the electronic device may output information indicating the point where the corresponding hardware component is located on the display based on the software coordinate information.

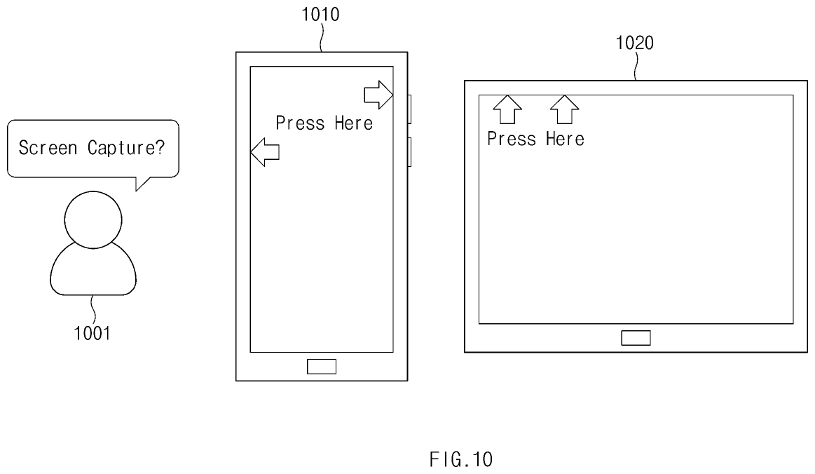

FIG. 10 is a diagram illustrating an example of an interface provided by electronic devices 1010 and 1020 (e.g., the electronic device 101 in FIG. 1 and the electronic device 300 in FIG. 3) according to various embodiments.

According to an embodiment, the electronic devices 1010 and 1020 may output an interface configured based on the information related to the hardware component. According to various embodiments, when receiving an input for executing a function of the electronic devices 1010 and 1020 from the user, the electronic devices 1010 and 1020 may output an interface indicating the information related to the hardware component (e.g., the position of the hardware component) required to perform the corresponding function. For example, when an input of asking a method for capturing a screen is received from the user, the electronic devices 1010 and 1020 may output an interface indicating the method for capturing the screen. For example, when an input of pressing a specific hardware button is received by the electronic devices 1010 and 1020, the screen may be captured. In this case, the electronic devices 1010 and 1020 may output an interface indicating a position of the button to be pressed to capture the screen based on the information related to the hardware component (e.g., the button). For example, the electronic devices 1010 and 1020 may output a text “Press Here” instructing to press the button on the screen together with an indication (e.g., an arrow) indicating the position of the button. According to various embodiments, the electronic devices 1010 and 1020 may obtain the information of the hardware component corresponding to each device from the database, thereby easily providing the information related to the hardware component of the corresponding electronic devices 1010 and 1020 when receiving the same input (e.g., a method for performing a specific function) from the user even in a case of different types of electronic devices. For example, each of the electronic devices 1010 and 1020 may have different positions of the buttons for the screen capture. For example, when the user makes a request for the same screen capture to the first electronic device 1010 and the second electronic device 1020 of the different types, the first device 1010 and the second device 1020 may appropriately provide the information related to the hardware component (e.g., the button) required to perform the function to the corresponding electronic device.

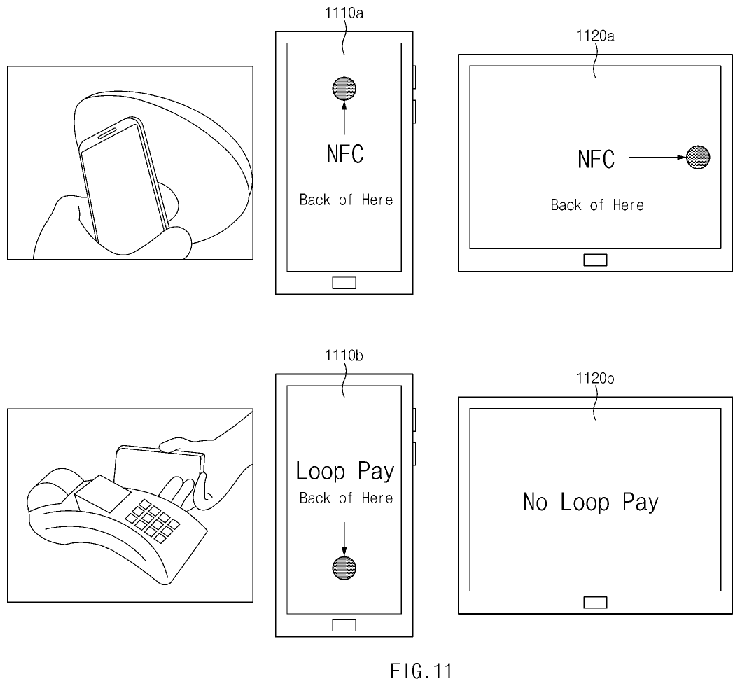

FIG. 11 is a diagram illustrating an example of an interface provided by electronic devices 1110a, 1110b, 1120a, and 1120b (e.g., the electronic device 101 in FIG. 1 and the electronic device 300 in FIG. 3) according to various embodiments.

According to an embodiment, the electronic device 1110a, 1110b, 1120a, and 1120b may output the interface configured based on the information related to the hardware component. For example, the electronic devices 1110a, 1110b, 1120a, and 1120b may output the interface indicating the information related to the hardware component (the position of the hardware component) used for the specific function. For example, in the first electronic devices 1110a and 1110b and the second electronic devices 1120a and 1120b of different types, the hardware components performing the same function may be disposed at different positions. According to an embodiment, the first electronic devices 1110a and 1110b and the second electronic devices 1120a and 1120b may obtain the requested information for the hardware component from the database, and may output the interface related thereto.

For example, when the user (or the application) requests information for the NFC module, the first electronic device 1110a may output information on a position of the NFC module on the display. For example, the first electronic device 1110a may output information indicating that the NFC module is located at a center of an upper end of a rear surface of the display. For example, the second electronic device 1120a, which is different from the first electronic device 1110a, may output information indicating that the NFC module is located at a center of a right side of the rear surface of the display.

For example, when the user (or the application) requests information related to a hardware component related to a payment function (e.g., Loop Pay), the first electronic device 1110b may output information indicating that there is the hardware component performing the payment function at a center of a lower end of the rear surface of the display. For example, the second electronic device 1110b may output information indicating that there is no hardware component for performing the payment function.

According to various embodiments disclosed in the disclosure, by defining the framework or the API that may provide the information related to the hardware component of each device regardless of the type of device, when information of the arbitrary hardware component is requested, the information related to the corresponding hardware component in the electronic device for which the request is generated may be easily provided.

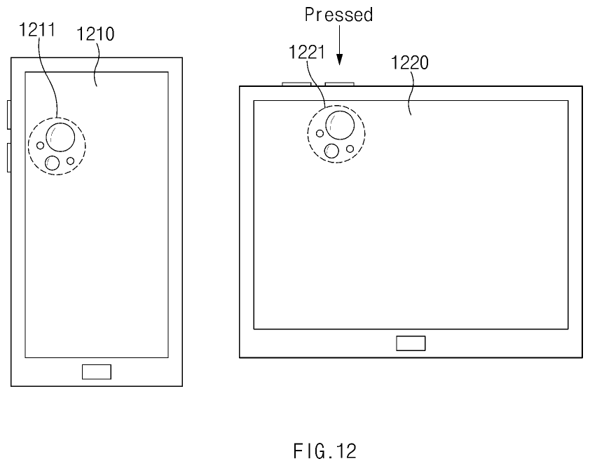

FIG. 12 is a diagram illustrating an example of an interface provided by electronic devices 1210 and 1220 (e.g., the electronic device 101 in FIG. 1 and the electronic device 300 in FIG. 3) according to various embodiments.

According to an embodiment, the electronic devices 1210 and 1220 may output the interface configured based on the information related to the hardware component. For example, when an input (e.g., the button or key press) related to the specific hardware component is received, the electronic devices 1210 and 1220 may output feedback based on the information related to the corresponding hardware component.

For example, when a lower left button is pressed in the first electronic device 1210, the first electronic device 1210 may provide feedback 1211 indicating that the button is pressed on a portion corresponding to a position of the pressed button on the display. For example, when an upper right end button is pressed on the second electronic device 1220, the second electronic device 1220 may provide feedback 1221 indicating that the button is pressed on a portion corresponding to a position of the pressed button on the display.

According to various embodiments, the electronic devices 1210 and 1220 may configure an interface that provides feedback related to the hardware component (e.g., the button), so that, when physical buttons placed at different positions on different devices are pressed, the same type of feedback may be provided based on information for the positions where the corresponding buttons are respectively disposed in the electronic devices 1210 and 1220.

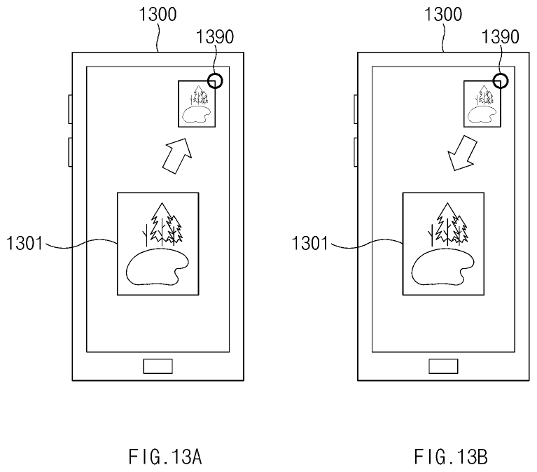

FIGS. 13A and 13B are diagrams illustrating an example of an interface provided by an electronic device 1300 (e.g., the electronic device 101 in FIG. 1 and the electronic device 300 in FIG. 3) according to various embodiments.

According to an embodiment, the electronic device 1300 may output the interface configured based on the information related to the hardware component. For example, when a specific function is performed in the electronic device 1300, the interface may be output based on information related to a hardware component related to the specific function. For example, when a camera function (an image capturing function) is performed in the electronic device 1300 in FIG. 13A, feedback in a form in which, based on a position of the related hardware component (e.g., a camera 1390), a captured image 1301 enters the position of the camera 1390. For example, when a gallery function is performed in the electronic device 1300 in FIG. 13B, based on the position of the related hardware component (e.g., the camera 1390), feedback in a form in which the image 1301 is output from the position of the camera 1390 may be provided.

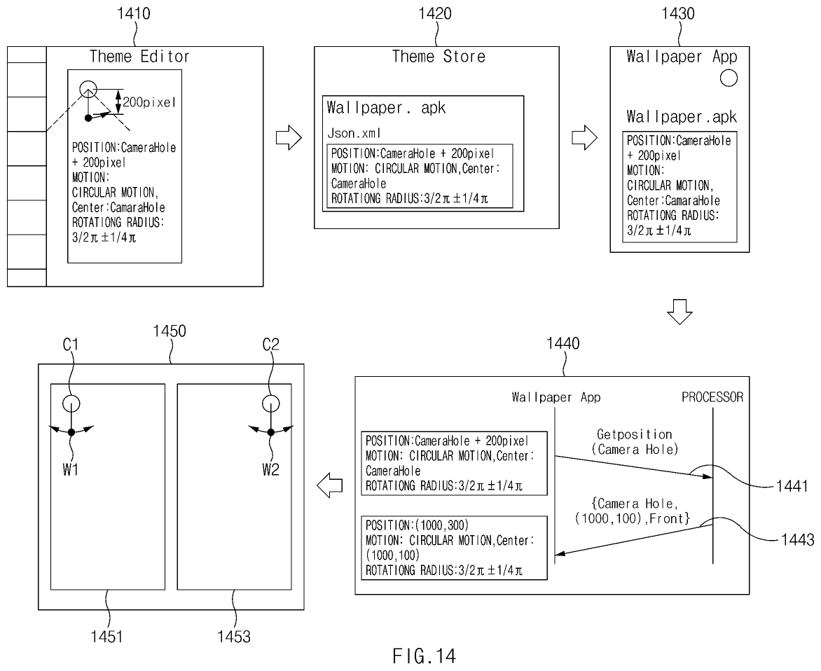

FIG. 14 is a diagram illustrating an example of an interface provided by an electronic device (e.g., the electronic device 101 in FIG. 1 and the electronic device 300 in FIG. 3) according to various embodiments.

According to an embodiment, in operation 1410, a content may be configured based on the information related to the hardware component of the electronic device. For example, a wallpaper may be configured based on information related to the specific hardware component. For example, the wallpaper may define an object or an image positioned at a certain distance (e.g., 200 pixels from a camera hole) to a position of the camera hole and moving in a circle with a certain rotation radius (e.g., 3/2π±1/4π). For example, the content (e.g., the wallpaper) may be defined through the application (e.g., a theme editor) of the electronic device or the external device.

According to an embodiment, in operation 1420, the configured wallpaper (e.g., a wallpaper application (wallpaper.apk)) may be uploaded to the external device (e.g., a theme store) and registered.

According to an embodiment, in operation 1430, the electronic device may download the content (e.g., the wallpaper (e.g., the wallpaper application (wallpaper.apk)) configured in operation 1410) configured based on the information related to the hardware component from the external device (e.g., the theme store).

According to an embodiment, in operation 1440, the electronic device may provide the information related to the hardware component to the application. For example, at least one application (e.g., the wallpaper application downloaded by the electronic device in operation 1430) stored in the electronic device may make a request for information related to the hardware component necessary for executing the received content to the processor (e.g., the framework), and receive the information related to the hardware component from the processor. For example, in operation 1441, the wallpaper application may make a request for information related to the hardware component (e.g., information related to a position of the camera (e.g., the position of the camera hole)) required to execute the downloaded wallpaper to the processor (e.g., the framework). In operation 1443, the processor may transmit the information for the camera position (e.g., software coordinate information indicating the camera position) to the wallpaper application. For example, the processor may transmit center coordinate information (e.g., (1000, 100)) of the camera (e.g., the camera hole) to the wallpaper application.

According to an embodiment, in operation 1450, the application may execute the content based on the information related to the hardware component provided by the processor. For example, the application may output a wallpaper containing objects W1 and W2 that move in a circle within a certain range from a center position of cameras C1 and C2 based on position information of the cameras C1 and C2 provided from the processor. For example, the content is merely configured to utilize the information related to the hardware component, and a hardware component for a specific device may not be previously determined. For example, the content is merely configured to provide the content using the camera position. Information related to the actual camera position may be configured to obtain, when a related application is executed in an arbitrary device, information related to the camera position in the corresponding device, so that even when different devices execute a content from the same source, different types of content may be provided based on the position of the hardware component of each device. For example, the application may be defined to display the object moving within the certain range based on the position of the camera hole in the electronic device, and may configure the content to be displayed after obtaining coordinate information for the camera hole of the corresponding electronic device from the processor. For example, when a first device 1451 and a second device 1453 with different arrangements of the hardware components (e.g., the cameras C1 and C2) download the content (e.g., the wallpaper) from the same source from the external device (e.g., the theme store) and provide the content, a wallpaper containing the object W1 that moves in the circle within the certain radius from a center of a camera hole C1 at an upper left end may be output because a position of the camera hole C1 is located at the upper left end of the first device 1451, and a wallpaper containing the object W2 that moves in the circle within the certain radius from a center of a camera hole C2 at an upper right end may be output because a position of the camera hole C2 is located at the upper right end of the second device 1453.

An electronic device according to an example embodiment may include: a display, a memory, and a processor electrically connected to the display and the memory. According to an embodiment, the memory may store instructions that, when executed, cause the processor to: search for information related to a hardware component of the electronic device from a database based on identification information or state information of the electronic device; and provide the information related to the hardware component to at least one application stored in the memory.

According to an example embodiment, the information related to the hardware component may include coordinate information set based on characteristics of the display of the electronic device.

According to an example embodiment, the instructions, when executed, may cause the processor to: search for information of the hardware component and a lower hierarchical hardware component from the database based on hardware hierarchical information; and provide at least one found information of the hardware component as the information related to the hardware component.

According to an example embodiment, the instructions, when executed, may cause the processor to convert physical coordinate information for the hardware component stored in the database into software coordinate information based on the characteristics of the display.

According to an example embodiment, the instructions, when executed, may cause the processor to store the software coordinate information in the database.

According to an example embodiment, the physical coordinate information may include three-dimensional coordinate information, and the software coordinate information may include two-dimensional coordinate information converted based on a resolution and a position of the display.

According to an example embodiment, the software coordinate information may include coordinate values of pixels of the display.

According to an example embodiment, the database may be included in an external device. According to an example embodiment, the memory may include the database.

According to an example embodiment, the instructions, when executed, may cause the processor to output an interface configured based on the information related to the hardware component through the display.

According to an example embodiment, the interface may contain at least one information of a size, a position, a use, and a usage of the hardware component, or a visual representation or a content related to the at least one information.

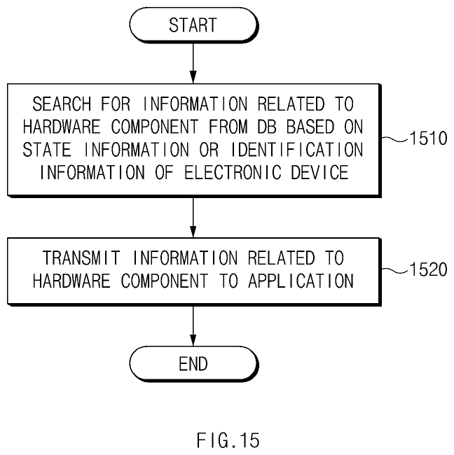

FIG. 15 is a flowchart illustrating an example information providing method of an electronic device according to various embodiments.

According to an embodiment, in operation 1510, the electronic device (e.g., the electronic device 101 in FIG. 1 and the electronic device 300 in FIG. 3) may search for the information related to the hardware component from the database based on the state information or the identification information of the electronic device. According to an embodiment, when the information for the hardware component is requested from the application stored in the electronic device, the electronic device may search for the information related to the hardware component from the database based on the state information or the identification information of the electronic device. For example, the application may make a request for the information for the hardware component to the framework. For example, the application may call the API that requests the information for the hardware component.

According to an embodiment, the electronic device may search for the information related to the hardware component (e.g., the software coordinate information of the hardware component) requested by the application from the database based on the hardware hierarchical information. For example, the hardware hierarchical information may be information that sets a hierarchical relationship of the hardware components as the parent class and the child class for the hardware components that the electronic device may include. For example, the electronic device may search for the information related to the hardware component requested by the application and information related to the hardware component of a lower class (the child class) of the hardware component requested by the application from the database. For example, when the application requests the information for the camera, the electronic device may search for the information related to all of the cameras (e.g., the front camera and the rear camera) from the database.

For example, the electronic device may search for the information related to the hardware component (e.g., the software coordinate information) corresponding to the state of the electronic device from the database based on the state (e.g., the folded state) of the electronic device. For example, the software coordinate information is the coordinates set based on the display characteristics (e.g., the screen resolution and the number of pixels) of the electronic device, so that, when the display of the electronic device is folded, software coordinates for the specific hardware component may become different. The electronic device may obtain software coordinate information suitable for a current state of the electronic device from the database based on the state of the electronic device.

According to an embodiment, in operation 1520, the electronic device may transmit the information related to the hardware component to the at least one application stored in the electronic device. For example, the electronic device may transmit the software coordinate information obtained from the database to the at least one application. For example, the electronic device may transmit the information related to the hardware component (e.g., the software coordinate information) to the application that has requested the information related to the hardware component.

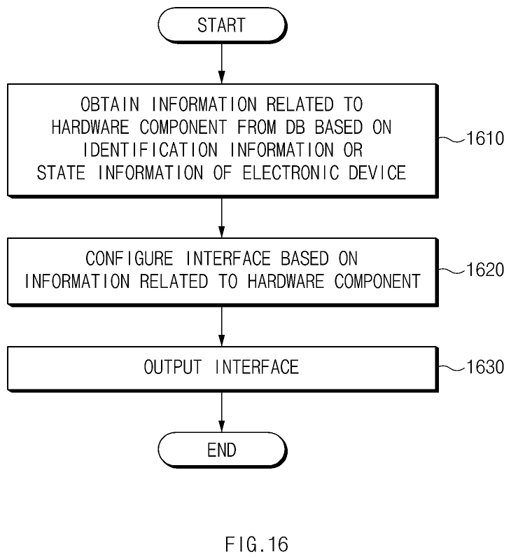

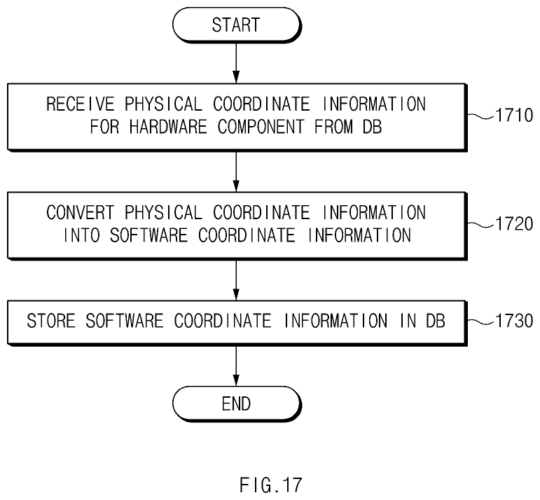

FIG. 16 is a flowchart illustrating an example information providing method of an electronic device according to various embodiments.

According to an embodiment, in operation 1610, the electronic device (e.g., the electronic device 101 in FIG. 1 and the electronic device 300 in FIG. 3) may obtain the information related to the hardware component from the database based on the identification information or the state information of the electronic device. For example, the electronic device may obtain the software coordinate information related to the hardware component of the corresponding electronic device from the database.

According to an embodiment, in operation 1620, the electronic device may configure the interface based on the information related to the hardware component. For example, the interface may contain at least one information of the size, the position, the use, and the usage of the hardware component, or the visual expression or the content related to the at least one information. For example, the electronic device may configure the interface that utilizes the information of the specific hardware component (e.g., the camera, the NFC module, the side button, and the antenna) of the electronic device.

According to an embodiment, in operation 1630, the interface may be output. According to various embodiments, the interface output by the electronic device is not based on a definitive data value for the hardware component of the specific device, but is based on the information related to the hardware component for each device obtained from the database, so that an output form of the interface may change depending on the device that outputs the interface. For example, when outputting an interface where a specific object is displayed at the camera position, an interface in which the specific object is displayed based on the camera position of the corresponding device may be output.

According to various embodiments, the interface may be configured using the information related to the hardware component (e.g., the position of the hardware component) of each device in the different devices, so that, even for interfaces of the same source, different types of interfaces may be output for the electronic devices.

FIG. 17 is a flowchart illustrating an example information providing method of an electronic device according to various embodiments.

According to an embodiment, in operation 1710, the electronic device (e.g., the electronic device 101 in FIG. 1 and the electronic device 300 in FIG. 3) may receive the physical coordinate information for the hardware component from the database. According to various embodiments, the database may exist outside the electronic device or may be included in the electronic device.

According to an embodiment, the physical coordinate information may be the three-dimensional coordinate information for the hardware component of the electronic device. For example, the physical coordinate information may be the absolute coordinate information for each position of the electronic device based on one point of the electronic device (e.g., the left uppermost end of the electronic device). For example, the physical coordinate information may use the mm units. According to an embodiment, the physical coordinate information may include the device identification information (the device ID), the hardware component name, and the physical coordinate value. For example, the physical coordinate information may have a format of {the hardware component name, (X mm, Y mm, Z mm)}. As another example, the Z axis-related information may be set to a simplified value based on the position of the hardware component. For example, the Z axis-related information of the physical coordinate information may be set to one of a ‘front’ exposed to the outside of a housing of the electronic device and representing a front surface, an ‘edge’ exposed to the outside of the housing of the electronic device and representing a side surface, a ‘back’ exposed to the outside of the housing of the electronic device and representing a rear surface, and an ‘inside’ representing an interior of the housing of the electronic device. In this case, the physical coordinate information may have a format of {the hardware component name, (X mm, Y mm, inside)}.

According to an embodiment, in operation 1720, the electronic device may convert the physical coordinate information into the software coordinate information. According to an embodiment, the software coordinate information may be the two-dimensional coordinate information set based on the display of the electronic device. For example, the software coordinate information may be relative coordinates with respect to a position in the display based on one point of the display (e.g., a left uppermost end of the display). For example, the software coordinate information, which is two-dimensional coordinates on a plane of the display, may use the pixel units. According to an embodiment, the software coordinate information may include the device hardware component name, and the software coordinate value. For example, the software coordinate information may have a format of {the hardware component name, (X pixel, Y pixel)}. According to an embodiment, the software coordinate information may further include the information of the simplified Z axis information (e.g., the front, the back, the inside, the edge, and the like) in the physical coordinates. According to an embodiment, each of the physical coordinate information and the software coordinate information, which is set for each type of the device, may further include the device ID information.

According to an embodiment, the electronic device may convert the physical coordinate information into the software coordinate information based on the display characteristics (e.g., the resolution and the number of pixels) of the electronic device. For example, the electronic device may convert the physical coordinate information into the software coordinate information based on the scheme described above with reference to FIGS. 8, 9A and 9B.

According to an embodiment, in operation 1730, the electronic device may store the software coordinate information in the database. According to an embodiment, when the information for the hardware component is requested from the user or the application stored in the electronic device, the electronic device may provide the software information stored in the database as the information related to the hardware component.

According to an embodiment, the coordinate conversion operation described with reference to FIG. 17 may be performed before performing the information providing method illustrated in FIG. 15 or FIG. 16.

According to various embodiments, operations similar or related to each other in the methods described with reference to FIGS. 15, 16 and 17 may be performed in conjunction with each other or may be performed independently. According to various embodiments, one or more operations described in FIGS. 15, 16 and 17 may be performed sequentially. In this case, some duplicated operations may be omitted.

A method for providing information of an electronic device according to an example embodiment may include: searching for information related to a hardware component of the electronic device from a database based on identification information of the electronic device or state information of the electronic device; and providing the information related to the hardware component to at least one application stored in a memory of the electronic device. According to an example embodiment, the information related to the hardware component may include coordinate information set based on characteristics of a display of the electronic device.

According to an example embodiment, the searching for the information related to the hardware component may include searching for information of the hardware component and a lower hierarchical hardware component from the database based on hardware hierarchical information.

According to an example embodiment, the providing of the information related to the hardware component may include providing at least one found information of the hardware component as the information related to the hardware component.

According to an example embodiment, the method may further include converting physical coordinate information for the hardware component stored in the database into software coordinate information based on the characteristics of the display.

According to an example embodiment, the method may further include storing the software coordinate information in the database.

According to an example embodiment, the physical coordinate information may include three-dimensional coordinate information, and the software coordinate information may include two-dimensional coordinate information converted based on a resolution and a position of the display.

According to an example embodiment, the software coordinate information may include coordinate values of pixels of the display.

According to an example embodiment, the database may be included in an external device. According to an embodiment, the memory may include the database.

According to an example embodiment, the method may further include outputting an interface configured based on the information related to the hardware component through the display.

According to an example embodiment, the interface may contain at least one information of a size, a position, a use, and a usage of the hardware component, or a visual representation or a content related to the at least one information.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor(e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a display;
a memory; and
a processor electrically connected to the display and the memory,
wherein the memory stores instructions that, when executed, cause the processor to:
search for information related to a hardware component of the electronic device from a database based on identification information or state information of the electronic device; and
provide the information related to the hardware component to at least one application stored in the memory,
wherein the information related to the hardware component includes coordinate information set based on characteristics of the display of the electronic device.

2. The electronic device of claim 1, wherein the instructions, when executed, cause the processor to:
search for information of the hardware component and a lower hierarchical hardware component from the database based on hardware hierarchical information; and
provide at least one found information of the hardware component as the information related to the hardware component.

3. The electronic device of claim 1, wherein the instructions, when executed, cause the processor to convert physical coordinate information for the hardware component stored in the database into software coordinate information based on the characteristics of the display.

4. The electronic device of claim 3, wherein the instructions, when executed, cause the processor to store the software coordinate information in the database.

5. The electronic device of claim 3, wherein the physical coordinate information includes three-dimensional coordinate information, and the software coordinate information includes two-dimensional coordinate information converted based on a resolution and a position of the display.

6. The electronic device of claim 5, wherein the software coordinate information includes coordinate values of pixels of the display.

7. The electronic device of claim 1, wherein the database is included in an external device.

8. The electronic device of claim 1, wherein the memory includes the database.

9. The electronic device of claim 1, wherein the instructions, when executed, cause the processor to output an interface configured based on the information related to the hardware component through the display.

10. The electronic device of claim 9, wherein the interface includes at least one information of a size, a position, a use, and a usage of the hardware component, or a visual representation or a content related to the at least one information.

11. A method for providing information of an electronic device, the method comprising:
searching for information related to a hardware component of the electronic device from a database based on identification information of the electronic device or state information of the electronic device; and
providing the information related to the hardware component to at least one application stored in a memory of the electronic device,
wherein the information related to the hardware component includes coordinate information set based on characteristics of a display of the electronic device.

12. The method of claim 11, wherein the searching for the information related to the hardware component includes:
searching for information of the hardware component and a lower hierarchical hardware component from the database based on hardware hierarchical information; and
wherein the providing of the information related to the hardware component includes:
providing at least one found information of the hardware component as the information related to the hardware component.

13. The method of claim 11, further comprising:
converting physical coordinate information for the hardware component stored in the database into software coordinate information based on the characteristics of the display.

14. The method of claim 13, further comprising:
storing the software coordinate information in the database.

15. The method of claim 13, wherein the physical coordinate information includes three-dimensional coordinate information, and the software coordinate information includes two-dimensional coordinate information converted based on a resolution and a position of the display.

16. The method of claim 15, wherein the software coordinate information includes coordinate values of pixels of the display.

17. The method of claim 11, wherein the database is included in an external device.

18. The method of claim 11, wherein the memory includes the database.

19. The method of claim 11, further comprising:
outputting an interface configured based on the information related to the hardware component through the display.

20. The method of claim 19, wherein the interface includes at least one information of a size, a position, a use, and a usage of the hardware component, or a visual representation or a content related to the at least one information.
